(19) United States
(12) Patent Application Publication
(10) Pub. No.: US 2012/0045937 A1
(43) Pub. Date: Feb. 23, 2012

(54) Junction box with support device for plug connector

(76) Inventors: Michael Richter, Schalksmuehle (DE); Dennis Gazke, Luedenscheid (DE)

(21) Appl. No.: 13/136,880

(22) Filed: Aug. 12, 2011

(30) Foreign Application Priority Data
Aug. 17, 2010 (DE) 102010034634.9-55

(51) Int. Cl. H01R 13/66

(52) U.S. Cl. 439/620.21

(57) ABSTRACT

A junction box, in particular for solar modules, including a base that is parallel to a mounting surface at the module and an inner cavity formed by a housing and closed by a cover, wherein a solar module contact is connected in the inner cavity with a connecting conductor for putting out generated electricity, wherein the connecting conductor exiting the inner cavity is provided with a plug connector which includes a plug-in device supporting a connecting contact and a safety device maintaining a plug connection, wherein the plug connector is arranged in a support device at the junction box, wherein the support device includes a plug-in mechanism that is complementary to the plug-in device, and wherein the plug connector is arranged at the plug-in mechanism through its plug-in device.

### RELATED APPLICATIONS

This application incorporates by reference and claims priority from German patent application DE 10 2010 034 634.9 filed on Aug. 17, 2010.

### FIELD OF THE INVENTION

The invention relates to a junction box, in particular for solar modules with a base that is parallel to a mounting surface at the module and with an inner cavity formed by a housing and closed by a cover, wherein a solar module contact is connected within the inner cavity with a connecting conductor for putting out electricity that is being generated, wherein the conductor exiting the inner cavity is provided with a plug connector which includes a plug-in device supporting a connecting contact and a safety device maintaining the plug connection, and wherein the plug connector is arranged in a support device at the junction box.

### BACKGROUND OF THE INVENTION

Junction boxes of this general kind are known, for example, from DE 10 2007 023 210 B3, DE 10 2007 027 861 A1 and DE 10 2007 060 023 A1.

The requirement to support plug connectors of the connecting conductors through a support device at the housing substantially originates from the requirements associated with automatically producing solar modules. In order to produce solar modules in a fully automated manner the junction boxes to be mounted on the solar modules are stored in stacks so that a respective assembly robot can access the junction boxes. Thus, the junction box is typically preassembled at the junction box manufacturer and provided with respective connecting conductors. In order to be able to deliver a neatly arranged stack the junction box conductors are typically directly secured at the junction box through plug connectors.

Securing the connecting conductors through plug connectors at the junction box has another substantial advantage. Transporting completed solar modules is substantially simplified through the connecting conductors being attached in an orderly manner. When setting up the solar modules at a site they can be connected with one another in a simple and quick manner through the plug connectors and optional intermediary components.

Eventually the plug connectors fixated at the junction box are relatively stable with respect to their positions during production of the solar module so that a procedure has been developed to contact the connecting contacts of the plug connectors with a testing device and to check the functionality of the junction box during assembly on the solar module.

However, it has become apparent that the prior art support devices for arranging the plug connectors at the junction box need improvement. Thus, on the one hand side there is the problem that a position of the connecting contacts based on material tolerances and fit clearances of the support devices but also possible transport induced movements of the plug connectors in the support device have a certain tolerance which makes automated functional testing more difficult.

When the support devices have more complex configurations which facilitate relatively exact positioning of the plug connector based on a particular shape of support device and plug connector, this has disadvantages for handling. Thus, inserting the plug connector into the support device causes particular complexity.

### BRIEF SUMMARY OF THE INVENTION

Thus, it is the object of the invention to provide a novel support device at a junction box for plug connectors, wherein the support device facilitates a safe arrangement for the plug connector and simple handling.

The object is achieved by a junction box with a base parallel to a mounting surface at a solar module and an inner cavity formed by a housing and closed by a cover, and wherein a solar module contact is connected in the inner cavity with a connecting conductor that outputs generated electricity. The connecting conductor exiting the inner cavity is provided with a plug connector which includes a plug-in device supporting a connecting contact and a safety device maintaining a plug connection and the plug connector is arranged in a support device at a junction box. The support device includes a plug-in mechanism that is complementary to the plug-in device and the plug connector is arranged at the plug-in mechanism through its plug-in device. The object is further achieved by a junction box with the characterizing features according to which the support device includes a plug-in mechanism that is complementary to the plug-in device, wherein the plug connector is arranged at the plug-in mechanism through the plug-in device of the plug connector.

According to the invention the support device is configured as a complementary opposite component for the plug connector to be arranged. Thus, the invention uses the fact that the plug connector itself includes support and safety devices due to its original function. These are support and safety devices are used for connecting its opposite component. These support and safety devices associated with the plug connector based on its original function are used by the junction box according to the invention for securing the plug connector for transport and assembly. This means in particular that a socket shaped plug connector is inserted into a support device which includes a configuration of a plug-in mechanism of a complementary plug. For a plug connector configured as a plug the respective support device includes the plug-in mechanism of a complementary socket.

The configuration of the junction box and its support device according to the invention facilitates a simple and safe arrangement of the plug connectors with a stable and defined position.

It is provided in an advantageous embodiment that the support device includes a safety element or means or element that is complementary to the safety device, wherein the plug connector is coupled through its safety device with the support device.

In this advantageous embodiment the support device does not only include a respective plug-in mechanism that is complementary to the plug connector, but it also includes a safety mechanism that is accordingly complementary, so that the safety devices of the plug connector are used for supporting the plug connector at the support device so that it cannot be lost and so that no separate safety devices have to be provided at the plug connector.

In an advantageous embodiment it is provided that the plug-in device is configured as a shaft and received by a dead-hole plug-in mechanism only maintaining a fit clearance.

It is furthermore provided that the safety device is configured as a snap locking engagement hook that is parallel to the shaft and which engages an engagement recess provided at the support device.

An alternative embodiment provides that the plug-in device is configured as a bore hole in which a plug-in mechanism configured as a shaft engages only maintaining a fit clearance.

This can be improved in that the safety device is configured as an engagement recess which is engaged by a safety device configured as a snap locking tab.

Thus, it is furthermore provided that the snap locking tab shaped safety device engages an engagement recess in the plug connector from an outside.

It is particularly advantageous when the coupling of junction box and plug connector facilitated through the safety device at the plug connector and the safety element or means at the support device is disengageable without a tool.

This configuration has the substantial advantage that the plug connectors are safely supported at the junction box for transport and assembly and that establishing plug connections with connecting conductors and the disengagement of the plug connectors from the support device can be provided in a quick and simple manner.

Thus, it is provided in particular that the safety element or means is configured so that the plug connector disengages from the support device when exceeding a defined pull force without damaging the safety devices.

### BRIEF DESCRIPTION OF THE DRAWINGS

The invention is described subsequently in more detail with reference to an exemplary, wherein:

FIG. 1 illustrates a top view of a junction box according to the invention; and

FIG. 2 illustrates the junction box according to FIG. 1 in a perspective view.

### DETAILED DESCRIPTION OF THE INVENTION

In the figures a junction box for solar modules is designated overall with the reference numeral 10.

The junction box 10 is provided in particular for mounting on solar modules and thus includes a base 11 which corresponds to its bottom side. The base 11 is configured parallel to a mounting surface of the solar module and is typically fixated at the solar module through gluing.

An inner cavity 13 enclosed by a housing 12 produced through an injection molding method provides access to the solar module contacts 14. The solar module contacts 14 are connected with solar module side conductors through welding or soldering and are configured as stamped components themselves. The solar module contacts 14 are electrically connected with functional components embedded in the housing material, in particular with bypass diodes. The bypass diodes are in turn connected with connecting conductors 15 leaving the junction box 10, wherein the connecting conductors are used for putting out electricity that is being generated.

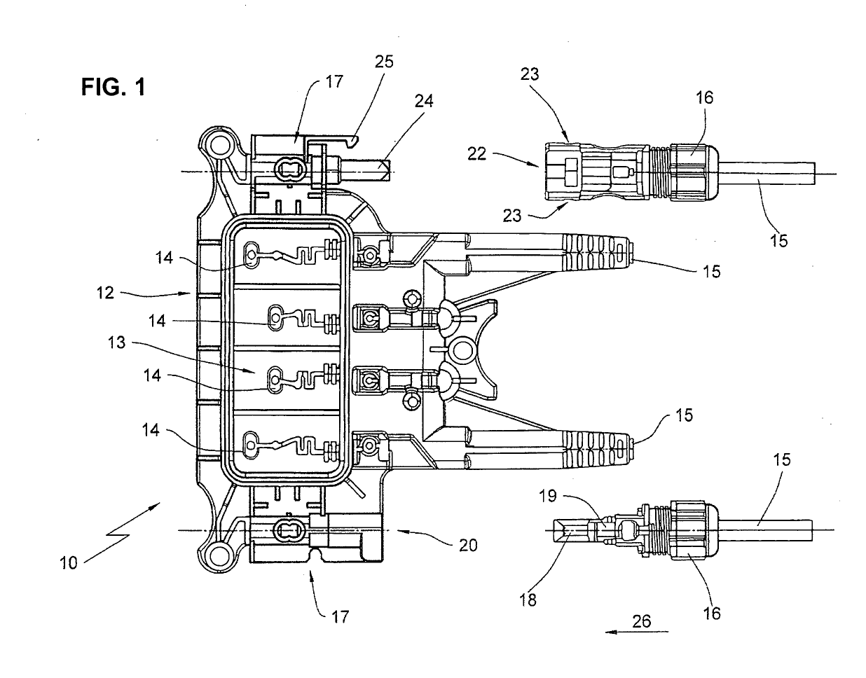

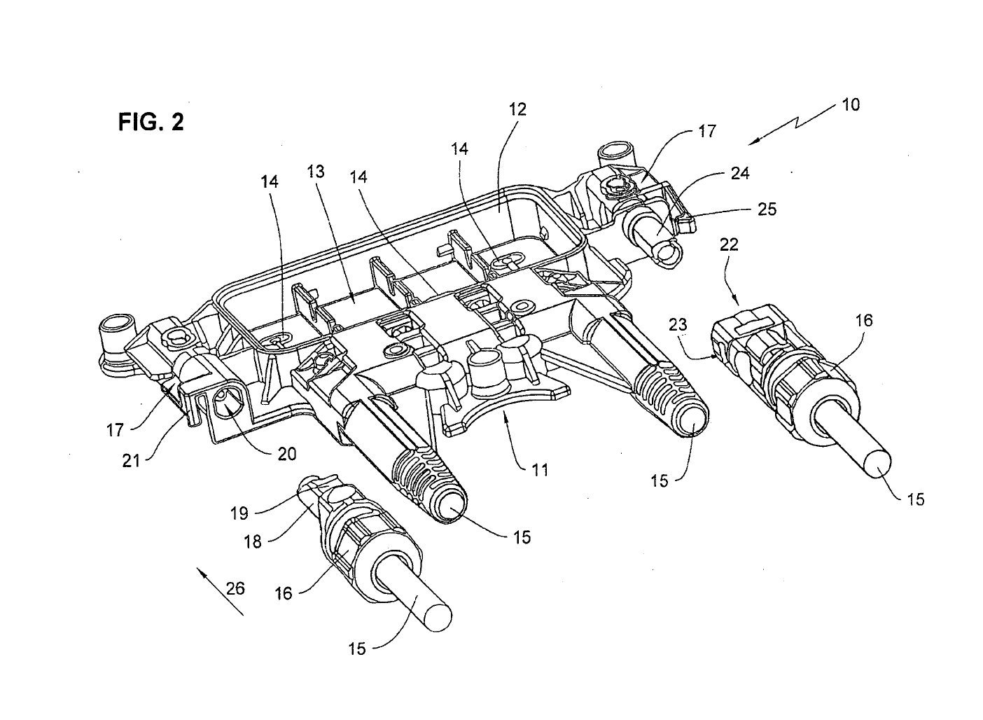

The connecting conductors 15 are provided with plug connectors 16 at their ends. The interruption illustrated in FIGS. 1 and 2 between the connecting conductors 15 which leave the junction box 10 and the connecting conductors 15 at whose ends the plug connectors 16 are arranged is only caused by the drawing technique. In fact these are respectively continuous conductors in reality.

Support devices 17 for the plug connectors 16 are arranged at a side of the housing and integrally configured therewith. The support devices include a shape and plug-in compatible plug-in mechanism with respect to the associated plug connector 16. The illustrated plug connectors 16 can therefore simply be connected with the respective support device 17.

The left plug connector 16 in the illustration includes a substantially shaft shaped plug-in device 18. Two safety devices configured as snap-locking engagement hooks 19 extend parallel to the shaft. The associated support device 17 includes a substantially dead hole shaped plug-in mechanism 20. A bar 21 arranged adjacent to the dead hole shaped plug-in mechanism interacts with the snap-locking engagement hooks 19.

In order to support the plug connector 16 that is arranged on a left side in the drawings it is inserted into the dead hole shaped plug-in mechanism 20 of the support device 17 with its shaft shaped plug-in device 18, wherein the left engagement hook 19 slides past the bar 21 and reaches behind the bar 21 securing the plug connector 16. Thus, the illustrated plug connector 16 has to be rotated about its longitudinal axis by 90° before being inserted into the support device 17.

The right plug connector 16 in the drawings includes a plug-in device which is configured as a bore hole 22. The safety devices of the plug connector 16 are formed by two engagement recesses 23. The associated support device 17 includes a shaft shaped plug-in mechanism 24. The safety element or means of the support device 17 includes a snap-locking tab 25.

In order to support the right side plug connector 16 it is inserted with its bore hole 22 into the shaft shaped plug-in mechanism 24 of the support device 17. Thus, the snap locking tab 25 engages an engagement recess 23 of the plug connector from an outside and secures the plug connector at the junction box 10.

An arrow provided with the reference numeral 26 symbolizes the insertion direction of the plug connectors 16 for arranging the respectively associated support device 17.

In conclusion a junction box 10 in particular for solar modules is described which includes a novel support device 17 for plug connectors 16. One major novelty of the support device 17 is a plug-in mechanism that is complementary to the respective plug connector 16 to be supported. Thus, the plug-in devices provided at the plug connector 16 are used for supporting the plug connector 16 at the junction box 10. In an exemplary embodiment, safety devices 21, 25 are provided at the junction box 10, wherein the safety devices 21, 25 cooperate with the safety devices 19, 23 at the plug connector 16 in order to safely support the plug connector 16 at the junction box 10.

### Reference Numerals and Designations

10 junction box

11 base

12 housing

13 inner cavity of 12

14 solar module contact

15 connecting conductor

16 plug connector

17 support device

18 shaft shaped plug-in device

19 engagement hook

20 dead hole shaped plug-in mechanism

21 bar

22 bore hole

23 snap locking recess

24 shaft shaped plug-in mechanism

25 snap locking tab

26 arrow

What is claimed is:

1. A junction box for a solar module comprising:
a base parallel to a mounting surface; and
an inner cavity formed by a housing and closed by a cover,
wherein a solar module contact is connected in the inner cavity with a connecting conductor that outputs generated electricity,
wherein the connecting conductor exiting the inner cavity is provided with a plug connector which includes a plug-in device supporting a connecting contact and a safety device maintaining a plug connection,
wherein the plug connector is arranged in a support device at a junction box,
wherein the support device includes a plug-in mechanism that is complementary to the plug-in device, and
wherein the plug connector is arranged at the plug-in mechanism through its plug-in device.

2. The junction box according to claim 1,
wherein the support device includes a safety element that is complementary to the safety device of the plug connector, and
wherein the safety element couples the plug connector through its safety device with the support device.

3. The junction box according to claim 1, wherein the plug-in device is configured with a shaft shape and received by a dead hole shaped plug-in mechanism maintaining a fit clearance.

4. The junction box according to claim 3, wherein the safety device is configured as a shaft parallel snap-locking engagement hook which engages an engagement recess at the support device.

5. The junction box according to claim 1, wherein the plug in device is configured as a bore hole in which a shaft shaped plug-in mechanism engages maintaining a fit clearance.

6. The junction box according to claim 5, wherein the safety device is configured as an engagement recess which is engaged by a snap locking tab shaped safety element at the support device.

7. The junction box according to claim 6, wherein the snap locking tab shaped safety element engages the engagement recess at the plug connector from an outside.

8. The junction box according to claim 2, wherein the coupling of the junction box and the plug connector provided by the safety device at the plug connector and the safety element at the support device is disengageable without tools.

9. The junction box according to claim 8, wherein the safety element is configured so that the plug connector disengages from the support device without damaging the safety devices when a defined pull force is exceeded.

10. The junction box according to claim 3, wherein the coupling of the junction box and the plug connector provided by the safety device at the plug connector and the safety element at the support device is disengageable without tools.

11. The junction box according to claim 10, wherein the safety element is configured so that the plug connector disengages from the support device without damaging the safety devices when a defined pull force is exceeded.

12. The junction box according to claim 6, wherein the coupling of the junction box and the plug connector provided by the safety device at the plug connector and the safety element at the support device is disengageable without tools.

13. The junction box according to claim 12, wherein the safety element is configured so that the plug connector disengages from the support device without damaging the safety devices when a defined pull force is exceeded.
